(19) United States
(12) Patent Application Publication
(10) Pub. No.: US 2005/0157688 A1
(43) Pub. Date: Jul. 21, 2005

(54) Compatibility between various w-lan standards

(76) Inventors: Gunnar Rydnell, Frolunda (SE); Jan Lindskog, Pixbo (SE); Stefan Rommer, Goteborg (SE); Per-Erik Johansson, Goteborg (SE)

Correspondence Address: ERICSSON INC., 6300 LEGACY DRIVE, M/S EVR C11, PLANO, TX, 75024, US

(21) Appl. No.: 10/507,050

(22) PCT Filed: Mar. 10, 2003
(86) PCT No.: PCT/SE03/00395

Related U.S. Application Data
(60) Provisional application No. 60/363,326, filed on Mar. 8, 2002.

(51) Int. Cl. H04L 9/00

(52) U.S. Cl. 370/338; 713/160; 709/249

(57) ABSTRACT

A method of performing selective filtering, a network comprising a station, an AP and a PAC, whereby synchronisation between the AP and the PAC is performed in order to allow filtering of messages in at least the AP or in the PAC has been provided. An AP is moreover provided being able to perform both legacy and 802.11i association and authentication, whereby if a 802.11i station is encountered, filtering is performed until a 802.11i association and authentication is successful, and if a legacy station is encountered allowing the station to initiate login procedure with a PAC, if the station is not authenticated by the PAC, filtering messages to the station in question.

### FIELD OF THE INVENTION

The present invention relates to security aspects in the area of public access Wireless LANs (WLAN). More specifically the invention concerns compatibility between various versions of the W-LAN standards in

### BACKGROUND

The majority of today's public access WLANs uses Access Points that conform to the IEEE 802.11 standard, in particular 802.11b. A newer standard 802.11a has also gained popularity. In the following the above standards will be referred to as legacy standards.

A forthcoming version of the standard, IEEE 802.11i, addresses improvement of Security. A need has been found for a new security framework overcoming the low level of security of 802.11b, including the now broken WEP encryption and MAC layer authentication. Therefore, a new encryption algorithm, AES, and a new authentication mechanism, based on mutual authentication, EAP signalling and 802.1x are included in the new security framework, as discussed in IEEE 802.11i.

WECA is an industry organization for promoting IEEE 802.11 WLAN and for establishing interoperability requirements for 802.11 products. WECA is also currently writing a recommended practice with the goal to increase the possibility for roaming between different Wireless Internet Service Providers (WISP). This recommended practice specifies a public access WLAN architecture that is briefly discussed below.

The current state of the art, as recommended by WECA's WISPr committee, is to place the task of authentication into a special network node, a Public Access Control (PAC) Gateway. The APs are all connected directly to the PAC and the only access to the rest of the network goes through the PAC (see FIG. 1).

The Access Points uses “open system” authentication and no encryption when communicating with the STAs. There is thus no access control in the APs. The real authentication and access control is done in the PAC gateway. Login credentials are transported between the STA and the PAC over HTTP protected by SSL. The process is as follows: When the user starts the laptop, the WLAN NIC associates with an AP. The user then starts a web browser on the STA. The PAC intercepts any HTTP request and sends a login web-page to the STA. The user enters username and password on the web page. The PAC then verifies the credentials, e.g. against a remote authentication server. If the credentials are ok, the PAC starts to forward traffic between the STA and the rest of the network.

It is claimed by WECA that this is the solution implemented by the majority of WISPs today. This architecture has also been implemented in the first release of Ericsson's WLAN-GPRS inter-working solution. In that solution, the PAC gateway is called Access Serving Node (ASN)).

An improved security standard for 802.11 has been suggested in IEEE 802.11i. This new standard will make it possible to perform a much-improved authentication in the AP than is possible with the 802.11-1999 standard. IEEE 802.11i will use IEEE 802.1X and EAP as the security framework. This means that there is no longer need for a web-based login in a PAC gateway, a satisfactory solution can be achieved with just 802.11i-capable APs and STAs. IEEE 802.11i also specifies enhanced encryption algorithms whose operation is closely tied to the 802.1X authentication procedure.

A security problem occurs when mixing legacy equipment, i.e. equipment compliant with existing standard, with 802.11i-capable equipment in the same cell. The problem is simply one of distributed responsibility. According to the WECA reference model for legacy WLAN networks, the PAC will be responsible for authenticating the legacy STAs, while the AP itself, according to the IEEE 802.11i model, will be responsible for authenticating new 802.11i STAs. Filtering and access control is thus done at two places in the network. This architecture may enable access for fraudulent users signalling to the AP that it is a legacy STA, while at the same time indicating to the PAC that it is a new 802.11i-enabled STA. It is seen that this STA may be accessing the system with no authentication at all.

### SUMMARY OF THE INVENTION

It is a first object of the invention to provide backwards compatibility for the new 802.11i, while supporting WEP and MAC layer authentication.

This object has been accomplished by the subject matter of claim 1.

Further advantages will appear from the following detailed description of the invention.

### BRIEF DESCRIPTION OF THE FIGURES

FIG. 1 shows a known architecture including a public access gateway providing WEP based authentication, and filtering if the provided authentication is not proved,

FIG. 2 shows a network architecture according to a first embodiment of the invention, including a PAC,

FIG. 3 shows 3 shows a flowchart for an access point of a first embodiment according to the invention,

FIG. 4 shows aspects of the signalling protocol relating to a legacy station, the associated AP and the PAC according to the first embodiment of the invention,

FIG. 5 shows aspects of the signalling protocol relating to a 802.11i station, the associated AP and the PAC according to the first embodiment of the invention,

FIG. 6 shows a flowchart for an access point of a second embodiment of the invention,

FIG. 7 shows aspects of the signalling protocol relating to a legacy station, the associated AP and the PAC according to the second embodiment of the invention, and

FIG. 8 shows aspects of the signalling protocol relating to a 802.11i station, the associated AP and the PAC, according to the second embodiment of the invention,

### DETAILED DESCRIPTION OF PREFERRED EMBODIMENTS OF THE INVENTION

### First Embodiment of the Invention

A new signalling protocol between AP and PAC has been provided according to the first embodiment of the invention.

In this solution, the PAC does the web-login and the APs implements the 802.11i functionality, according to the reference architecture advised by WECA and IEEE. Both legacy and 802.11i STAs can authenticate. Legacy STAs authenticate over the web interface against the PAC gateway and 802.11-capable STAs authenticate using EAP and 802.1X in the AP. Authentication is usually performed against a backend server (a AAA server) and it is only the access control function that is performed by the AP and PAC respectively. We will however not address details regarding a potential AAA server since it is the access control function that is central to this embodiment. Authentication against an AAA server is one possible implementation.

In order to coordinate the access control state machines in the AP and the PAC a new signalling protocol between AP and PAC has to be introduced. There are several possible alternatives:

### First Alternative of First Embodiment

In this solution the PAC is responsible for web-login but is otherwise completely transparent. The AP on the other hand filters all frames to/from unauthenticated STAs and shall only forward frames from authenticated STAs.

If an 802.11i-capable STA associates with the AP and performs a successful 802.1X-authentication, the AP starts to forward frames to/from this STA.

If a legacy STA associates with the AP, the PAC has to authenticate it. The AP shall send frames from the STA to the PAC in a recognizable and preferably secure way. The AP could e.g. encapsulate the frames in an IPSec tunnel to the PAC. The AP and PAC could also share a secret that the AP uses to encrypt and authenticate each frame. In any case, the PAC can recognize these packets as traffic coming from an unauthenticated STA. The PAC can then process these packets. If the packets e.g. contain DHCP requests or HTTP requests for the login web page, the PAC responds to the requests while other packets are discarded. When the web-login is successfully completed, the PAC sends a special message to the AP telling it, that the STA is authenticated and that the AP can start to forward traffic to/from the STA without encapsulating it in any special way.

An advantage of this solution is that the network architecture can be relaxed; not all traffic has to pass through the PAC. Instead the PAC could be any kind of PC with a HTTP/SSL server (see example in FIG. 2).

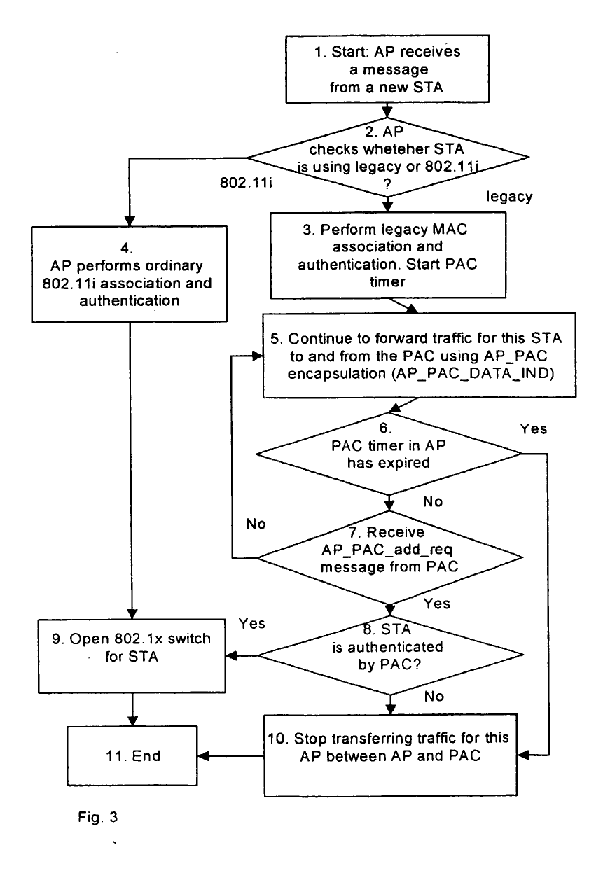

According to step 1 in FIG. 3 the AP receives a message form the AP, step 1, whereupon the AP determines whether the station is a legacy station or an 802.11i station, step 2.

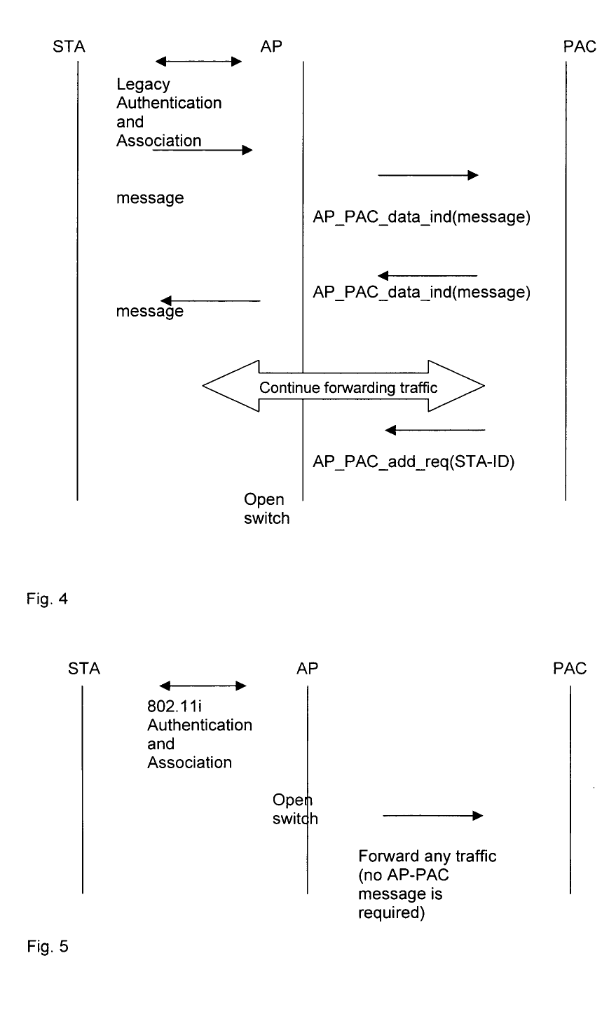

As illustrated in FIG. 4, the normal legacy procedure for association and authorisation is carried our enabling the station to communicate with AP. This has been shown by step 3 in FIG. 3.

Any message from the station in question will trigger a following AP-PAC_data_ind message from the AP towards the PAC, indicating to the PAC that the station needs authentication before the PAC.

In order to accomplish login, a PAC timer may be set in the AP and traffic is forwarded to and from the PAC for instance using AP_PAC encapsulation, step 5.

The PAC, in turn, transmits a WEB based Login page to the AP, which is delivered to the station. The user of the station may then provide the credentials according to the normal procedure for login, for instance a secret PIN code.

The PAC responds with an AP_PAC_add_req message, step 7, informing whether the PAC has accepted or barred the station. If the station is authenticated, step 8, the AP “opens the switch” in the AP, and allows traffic from the station to pass without filtering.

If the login procedure could not be completed within the time limit indicated according to the PAC timer and the test according to step 6, the AP stops transferring traffic from the particular station.

If—instead of a legacy station—a 802-11i station is detected in step 2, the legacy station associates and authenticates with the AP according to the ordinary 802.11i procedures, as shown in FIG. 5, the AP “opens the switch” and forwards any traffic. No AP_PAC message is required before the PAC. These steps have been shown in step 4 and 9 in FIG. 3

### Second Alternative of First Embodiment

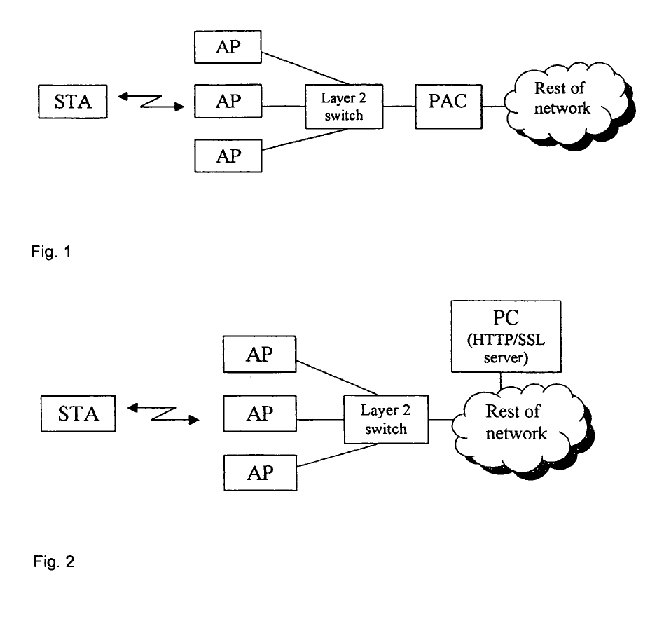

In this solution, the filtering of unauthenticated traffic is performed by the PAC and not by the AP. If the AP receives a frame not destined to it, it always forwards the frame. It is then up to the PAC to filter unauthenticated frames and to perform the web-login procedure. For this purpose, an architecture according to FIG. 1 is chosen.

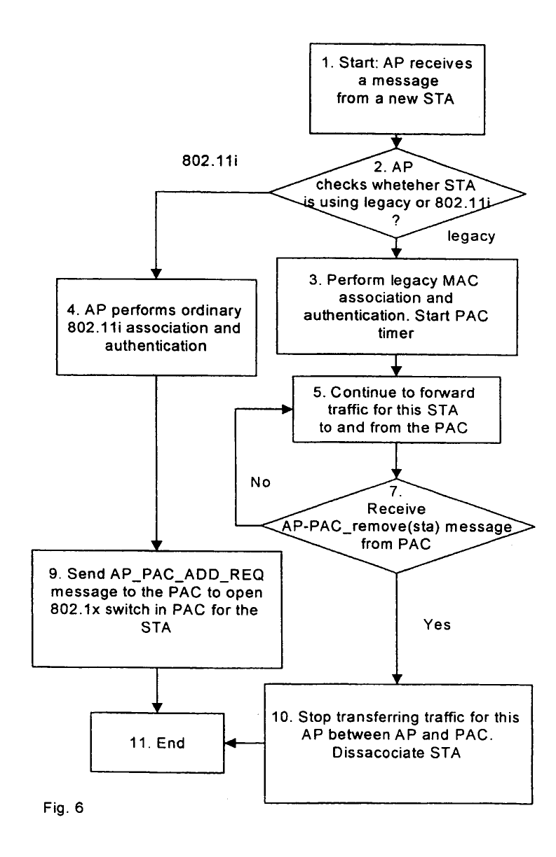

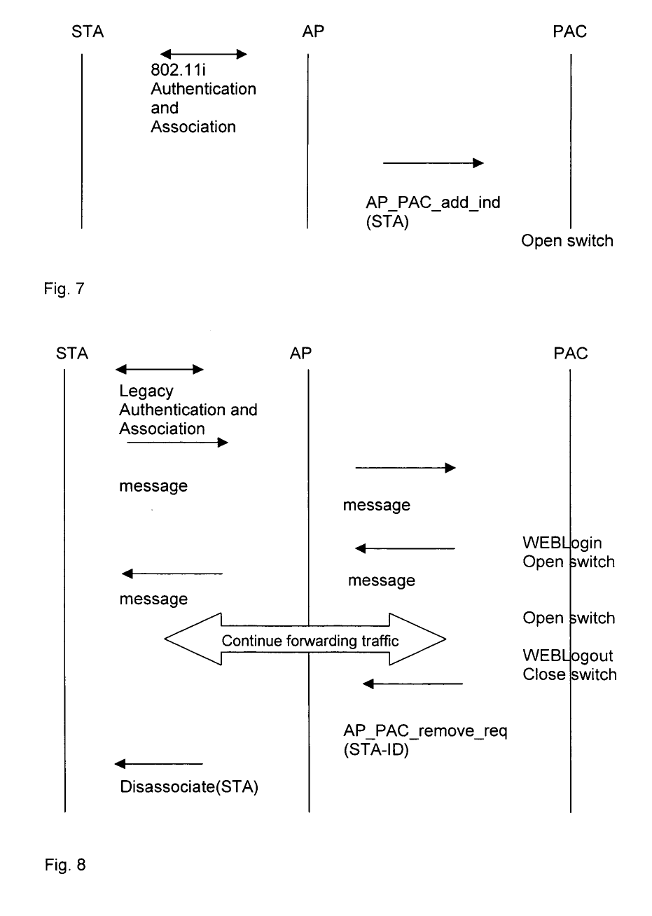

In FIG. 6, this procedure has bee shown, whereby in step 1 the AP receies amessage from a new station and in step 2 the AP determines whether a legacy or 802.11i station is encountered.

If an 802.11i-capable STA sends EAP frames destined to the AP, the AP processes these (possibly by forwarding them to a AAA server) and performs the 802.1X-authentication procedure, cf. step 4 in FIG. 6. If the procedure is successful, the AP sends a special message to the PAC, step 9, indicating that the STA is authenticated and that the PAC should start forwarding frames to/from this STA. This message should preferably be sent in a secure way.

If—on the other hand—a legacy STA associates with the AP, as illustrated in FIG. 8, the AP performs the normal legacy association and authentication procedure, step 3. At the same time, a PAC timer is set in the AP with the same purpose as set out above. The AP continues to forward traffic to and from this station, step 5. If during this time, the station sends any message to the PAC, the PAC responds with the WEB login page back to the station. If a correct password is received in the PAC from the station, the PAC opens the switch in the PAC. If on the other hand an erroneous password is received, the PAC closes the switch and transmits a AP_PAC_remove_req to the AP, step 7, effectuating a stop of transferring of traffic for the AP in question between the AP and the PAC and effectuating a disassociation of the station before the AP, step 10.

### Third Alternative of First Embodiment

According to the third alternative of the first embodiment, both AP and PAC performs filtering

This solution is a combination of solutions above. In order for traffic from an STA to pass, both the AP and the PAC must forward the frame.

### Second Embodiment

According to the second embodiment of the invention, configuration of the network is performed in legacy (insecure) or 802.11i (secure) mode.

A simple solution is to run the network in either legacy mode or 802.11i mode. In the former case, login is done over HTTP/SSL and 802.11i-capable STAs have to run (if possible) in a legacy mode. In the latter case, legacy STAs are unable to authenticate to the AP, only 802.11i-capable STAs may authenticate. For real 802.11i level of security, i.e. no legacy STAs are accepted to enter the network, the latter case is the only solution.

### Third Embodiment

According to the third embodiment, the AP does all authentication functions In this solution, the web-login functionality is moved from the PAC to the APs. HTTP/SSL servers therefore have to be implemented in each AP. Both legacy and 802.11i STAs can now authenticate in a single cell, the AP has to adjust the authentication procedure (web-login or 802.1X-authentication) to the capabilities of the STA.

The method described in solution 3 extends typical implementations, e.g. Ericssons ASN solution, of the WECA reference model.

### Fourth Embodiment

According to the fourth embodiment of the invention, the PAC does all authentication functions

In this solution, the PAC keeps the web-login. The 802.11i functionality is divided between the AP and the PAC. Encryption according to 802.11i (requiring HW support) is still done in each AP but the IEEE 802.1X and EAP support is implemented in the PAC gateway. As in solution 3, both legacy and 802.11i STAs can authenticate but now the PAC has to adapt to the capabilities of the STA.

Since establishment and refreshing of session encryption keys is done by 802.1X and EAP (in the PAC) and the actual encryption/decryption is performed in the AP, a AP-PAC protocol is invented to transport keying material between the APs and the PAC gateway. This protocol is similar to the one outlined in solution 1, and not described further now.

The method described in solution 4 is violating the IEEE reference model.

In conclusion, the invention describes a new solution to the well-known security problem in 802.11 WLANs. The method is compatible with protocols standardised by IEEE and WECA, but goes one step further and specifies a new protocol between the network nodes in the WECA reference architecture. Furthermore, 3 alternative methods are described, including modifications to security architecture described by the WECA reference architecture.

A mechanism, such as described here, will be necessary in order to provide a secure WLAN network when 802.11i equipment will start to appear on the market. It is not a new authentication mechanism that is invented; authentication of a STA is done using the WECA and the IEEE authentication methods. The invention solves the problem of distributed responsibility, by tying together the WECA and IEEE security protocols and synchronising the security information in the fixed nodes in the WLAN backbone.

1-3. (canceled)

4. A wireless access point (AP) operative to perform authentication for both legacy 802.11x and 802.11i wireless stations, wherein:
if an 802.11i wireless station is encountered by said AP, filtering is performed until a 802.11i association and authentication is completed;
if a legacy 802.11x wireless station is encountered by said AP, allowing the wireless station to initiate a login procedure with a Public Access Control gateway (PAC); and,
if the 802.11x wireless station is not authenticated by the PAC, filter all messages from the wireless station.

5. The AP according to claim 4, wherein:
if a legacy 802.11x wireless station is encountered, in order to accomplish login, a PAC timer is set and traffic is forwarded by said AP to and from the PAC using encapsulation, and transmitting a message from said AP to said PAC indicating that the wireless station needs authentication, said PAC operative to transmit a web based login page to the legacy 802.11x wireless station.

6. The AP according to claim 5, wherein said AP waits for a message from the PAC indicative of successful authorisation of the legacy 802.11x wireless station and, once received, allows traffic to and from the legacy 802.11x wireless station without filtering.
